(19) United States
(12) Patent Application Publication
(10) Pub. No.: US 2002/0138219 A1
(43) Pub. Date: Sep. 26, 2002

(54) Quality assurance automatic display system

(75) Inventor: Yoshikazu Nagamura, Tokyo (JP)

Correspondence Address: McDermott, Will & Emery, 600 13th Street, N.W., Washington, DC, 20005-3096, US

(73) Assignee: Mitsubishi Denki Kabushiki Kaisha

(21) Appl. No.: 09/974,834

(22) Filed: Oct. 12, 2001

(30) Foreign Application Priority Data
Mar. 23, 2001 (JP) 2001-085098

(51) Int. Cl. G06F 19/00

(52) U.S. Cl. 702/81

(57) ABSTRACT

There is provided a user-friendly quality assurance automatic display system which enables a user of semiconductor devices to readily ascertain correct quality assurance relating to the quality of semiconductor devices and to use the semiconductor devices in a carefree manner. Inspection item graded data—which have been graded by determination of reliability of a substance to be inspected for each inspection item—are held in an inspection item data hold section of a data processor. Inspection item graded data held in the inspection item data hold section are transported to a data processing section of the data processor. Subsequently, general graded data pertaining to the degree of quality assurance of the substance are determined in accordance with an algorithm employed in the data processing section. The general graded data determined by the data processing section are transported to a display device, where the general graded data are displayed on the display device.

### BACKGROUND OF THE INVENTION

1. Field of the Invention

The present invention relates to a quality assurance automatic display system, and more particularly, to a quality assurance automatic display system relating to inspection of a semiconductor device such as an LSI, inspection of a photomask, or inspection of photomask indirect materials such as a blank.

2. Background Art

In the majority of industrial products, semiconductor devices, such as LSIs, have recently been used as important parts. It is no exaggeration to state that the quality of a semiconductor device determines the quality of an overall industrial product. Therefore, manufacturers of semiconductor devices guarantee the quality of semiconductor devices by way of performing various tests.

In general, inspection items relating to a semiconductor device are classified primarily into the following categories. Namely, inspection items are classified into inspection items for which a substantially large volume of semiconductor devices are to be inspected at substantially 100% frequency, and inspection items for which some of semiconductor devices are sampled on a per-lot-basis and the thus-sampled semiconductor devices are inspected. Particularly, the latter inspection items include, for example, an inspection for verifying an operation characteristic, such as an electrical characteristic, by means of a tester, and an inspection for verifying the long-term stability and durability of a semiconductor device through accelerated tests conducted in a hostile environment. However, these inspections are subjected to time and cost restrictions, and hence difficulty is encountered in subjecting all the semiconductor devices to these inspections. Even an inspection of some of a large volume of semiconductor devices assures the quality of the overall lot to a certain extent by means of thorough control of quality of other materials and manufacturing processes.

Japanese Patent Application Laid-Open No. 346246/1992 describes a technique of grading the quality of a semiconductor device according to results of a plurality of inspection of a semiconductor device.

According to the related-art technique set forth, only the inspection data are taken as standards when quality of a semiconductor device is guaranteed. The difference in reliability (degree of assurance) between inspections which differ from each other in terms of inspection devices and methods has never been taken into account. More specifically, a plurality of inspection items are set for a single semiconductor device, and the degree of assurance vary according to the plurality of inspection items. For example, when all semiconductor devices have been subjected to an inspection relating to a certain inspection item, the degree of assurance of the inspection is high. In contrast, when a sampling inspection is performed through an accelerated test with regard to a certain inspection item, the result of the sampling inspection has a lower degree of assurance than does the result of the 100% inspection.

In relation to an identical inspection item, the degree of assurance of the inspection may vary from one inspection apparatus to another inspection apparatus. Variations arise in inspection sensitivity or accuracy if a manufacturer of inspection apparatus is changed, if an inspection apparatus manufactured by an identical manufacturer is changed in model or replaced with another apparatus of the same model, or if an inspection apparatus is used in a different setup or usage condition.

However, variations in the degree of assurance in connection with individual inspection items have not been reflected in the degree of assurance of overall quality of a semiconductor device.

It is important for the user of semiconductor devices to ascertain correct quality assurance relating to the quality of a semiconductor device and to be able to take semiconductor devices into his industrial products in a carefree manner.

This problem is not limited to semiconductor devices and has become common to photomasks and photomask indirect materials, such as blanks. The quality of a photomask directly affects the quality of a pattern formed on a semiconductor substrate. The quality of a photomask indirect material, such as a blank, affects the quality of a photomask.

### SUMMARY OF THE INVENTION

The present invention has been conceived to solve the problem set forth and is aimed at providing a user-friendly quality assurance automatic display system which enables a user of semiconductor devices to readily ascertain correct quality assurance relating to the quality of semiconductor devices and to use the semiconductor devices in a carefree manner.

According to one aspect of the present invention, a quality assurance automatic display system comprises a data processor having an inspection item data hold section and a data processing section. The inspection item data hold section holds inspection item graded data which have been graded by determination of reliability of a per-inspection-item for a substance to be inspected. The data processing section determines general graded data pertaining to the degree of quality assurance of the substance in accordance with an algorithm employed in the data processing section after having received the inspection item graded data from the inspection item data hold section. Further the system comprises a display device for displaying the general graded data transported from the data processing section.

Other and further objects, features and advantages of the invention will appear more fully from the following description.

### BRIEF DESCRIPTION OF THE DRAWINGS

FIG. 1 is a block diagram showing the quality assurance automatic display system according to the first embodiment of the present invention.

FIG. 2 is a table showing data stored in the inspection item data hold section in the quality assurance automatic display system according to the first embodiment of the present invention.

FIG. 3 is a flowchart pertaining to the quality assurance automatic display system according to the first embodiment of the present invention.

FIG. 4 is a table showing data stored in the inspection item data hold section in the quality assurance automatic display system according to the second embodiment of the present invention.

FIG. 5 is a block diagram showing the quality assurance automatic display system according to a third embodiment of the present invention.

### DETAILED DESCRIPTION OF THE PREFERRED EMBODIMENT

### First Embodiment

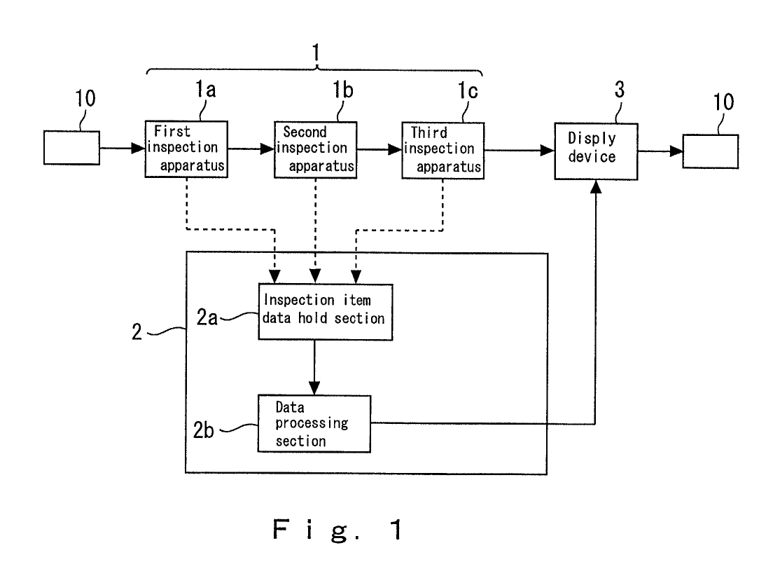

A first embodiment of the present invention will be described in detail hereinbelow by reference to a drawing. FIG. 1 is a block diagram showing the quality assurance automatic display system according to the first embodiment.

As shown in FIG. 1, reference numeral 1 designates pieces of inspection apparatus for inspecting objects to be inspected with regard to various inspection items; 1a designates a first inspection apparatus for performing an inspection relating to a first inspection item; 1b designates a second inspection apparatus for performing an inspection relating to a second inspection item; 1c designates a third inspection apparatus for performing an inspection relating to a third inspection item; 2 designates a data processor; 2a designates an inspection item data hold section; 2b designates a data processing section; 3 designates a display device; and 10 designates a semiconductor device which is taken as an object to be inspected.

In the quality assurance automatic display system having the foregoing construction, a semiconductor device 10 is transported to the first inspection apparatus 1a of the pieces of inspection apparatus 1. The first inspection apparatus 1a performs an inspection of the semiconductor device 10 with regard to the first inspection item; e.g., appearance.

The semiconductor device 10 that has finished undergoing the first inspection in the first inspection apparatus 1a is transported to the second inspection apparatus 1b. The second inspection apparatus 1b performs an inspection of the semiconductor device 10 with regard to the second inspection item; e.g., an electric characteristic.

The semiconductor device 10 that has finished undergoing the second inspection in the second inspection apparatus 1b is transported to the third inspection apparatus 1c. The third inspection apparatus 1c performs an inspection of the semiconductor device 10 with regard to the third inspection item; e.g., a burn-in.

The semiconductor device 10 that has finished undergoing inspections in the pieces of inspection apparatus 1 is transported to the display device 3. General graded data to be described later are displayed on the display device 3.

Inspection items graded data corresponding to inspection items for which the pieces of inspection apparatus 1a, 1b, and 1c perform inspections are input and held in the inspection item data hold section 2a of the data processor 2.

The inspection item graded data are results of determination of reliability of inspections obtained by means of taking the pieces of inspection apparatus 1a, 1b, and 1c and the inspection methods as references. In other words, inspections pertaining to the inspection items are graded with respect to reliability, by taking into consideration information unique to the pieces of inspection apparatus 1a, 1b, and 1c, such as inspection sensitivity and accuracy, as well as taking into consideration information unique to inspection methods, such as the frequency of inspection, inspection conditions, specifications, and an inspection environment. Inspections pertaining to inspection items are graded with respect to reliability.

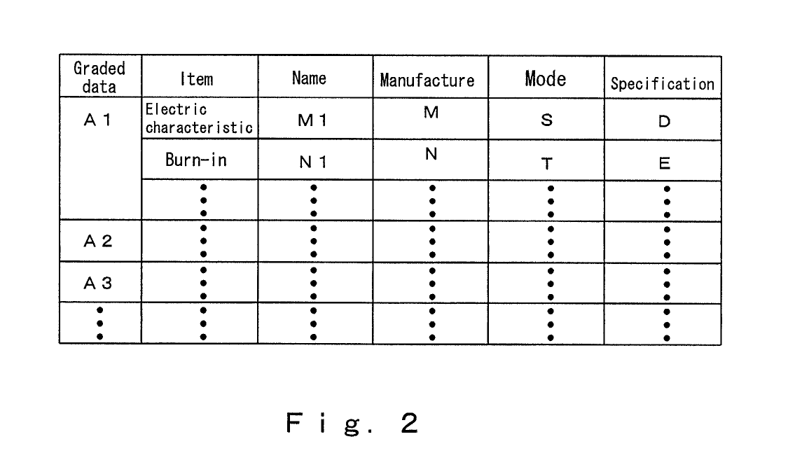

As shown in FIG. 2, in relation to an inspection about an electric characteristic to be performed by the second inspection apparatus 1b, the name of inspection apparatus (M1), the manufacturer of the inspection apparatus (M), an inspection mode (i.e., an inspection method) (S), and inspection specifications (D) are stored in the inspection item data hold section 2a as the inspection item graded data. From these data sets, the inspection item graded data are determined to be A1. In relation to an inspection about burn-in to be performed by the third inspection apparatus 1c, the name of inspection apparatus (N1), the manufacturer of the inspection apparatus (N), an inspection mode (T), and inspection specifications (E) are stored. From these data sets, the inspection item graded data are determined to be A1. In relation to a plurality of inspection items, inspection item graded data are determined.

The inspection item graded data held in the inspection item data hold section 2a are transported to the data processing section 2b provided in the data processor 2. Subsequently, general graded data pertaining to the degree of quality assurance of the semiconductor device 10 are determined by means of an algorithm employed in the data processing section 2b. The algorithm employed in the data processing section 2b is weighted for each inspection item. For instance, when the inspection item graded data pertaining to an electrical characteristic are determined to be A1, the inspection item graded data pertaining to burn-in are determined to be A1, and inspection item graded data pertaining to another inspection item are determined to be A1, general graded data are determined to be A1. In contrast, when the inspection item graded data pertaining to an electrical characteristic are determined to be A2 and inspection item graded data pertaining to burn-in and inspection item graded data pertaining to another inspection item are determined to be A1, general graded data are determined to be A2.

The general graded data determined by the data processing section 2b of the data processor 2 are transported to the display device 3, where the general graded data are displayed. Here, the display device 3 is embodied in a printer. For example, general graded data, such as “A1” or “A2,” can be inscribed directly on a package of the semiconductor device 10 by means of a laser marker.

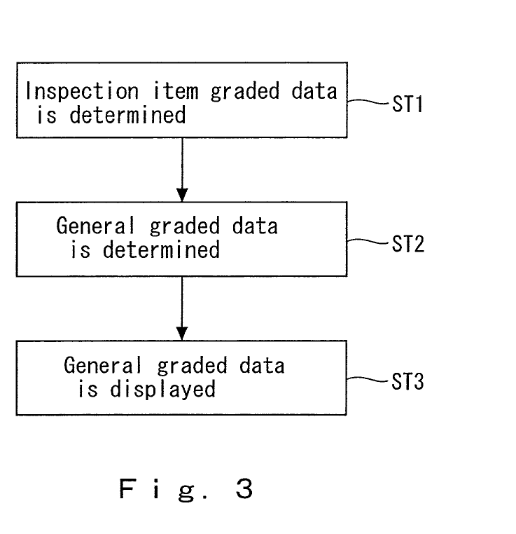

FIG. 3 is a flowchart pertaining to the quality assurance automatic display system according to the first embodiment. Processing flow of the quality assurance automatic display system according to the first embodiment is summarized as follows. Inspection item graded data representing reliability are determined for each inspection item (step ST1). The inspection item graded data are input to the inspection data hold section 2a. Next, the inspection item graded data are transported to the data processing section 2b, where general graded data are determined on the basis of the inspection item graded data sets (step ST2). Finally, the general graded data are transported to the display device 3, where the general graded data are displayed on the display device 3 (step ST3).

As has been described, when the quality of the semiconductor device 10 is assured, the quality assurance automatic display system embodied as mentioned in connection with the first embodiment grades inspections in consideration of variations in reliability attributable to a difference between the pieces of inspection apparatus 1a, 1b, and 1c and attributable to a difference between inspection methods. The resultant grade is provided on the semiconductor device 10, thereby enabling a user to ascertain the correct degree of quality assurance.

Manufacturers which supply the semiconductor device 10 can set appropriate prices for the semiconductor device 10 in accordance with the correct degree of quality assurance.

In the first embodiment, the three pieces of inspection apparatus 1a, 1b, and 1c of the pieces of inspection apparatus 1 are employed for the sake of simplicity. Even when inspection apparatus differing in number from the three pieces of inspection apparatus are employed, there is naturally yielded an advantage equal to that described in connection with the first embodiment.

In the first embodiment, each of the three pieces of inspection apparatus 1a, 1b, and 1c has performed one inspection item. Even when a single piece of inspection apparatus performs inspections relating to a plurality of inspection items, there is yielded an advantage identical with that yielded in the first embodiment.

In the first embodiment, one inspection apparatus and one inspection mode are assigned to one inspection item. However, even when a plurality of pieces of inspection apparatus or a plurality of inspection modes are assigned to one inspection item, there is yielded an advantage equal to that yielded in the first embodiment.

The general graded data appearing on the display device 3 can be inscribed directly on the semiconductor device 10. In addition, the general graded data can be printed on a set of specifications, brochure, and housing case of the semiconductor device 10.

The quality assurance automatic display system according to the first embodiment is provided with one data processor 2. However, there may be provided a plurality of data processors 2, and the processors 2 may be networked together. The inspection item graded data to be held in the inspection item data hold section 2a and the data to be stored in the data processing section 2b can be exchanged among the plurality of data processors 2. As a result, an advantage analogous to that yielded in the first embodiment can be yielded over a wide range.

### Second Embodiment

A second embodiment of the present invention will now be described in detail by reference to drawings. A quality assurance automatic display system according to the second embodiment differs from that described in connection with the first embodiment, only in that a photomask is taken as an object to be inspected in lieu of the semiconductor device 10 shown in FIG. 1.

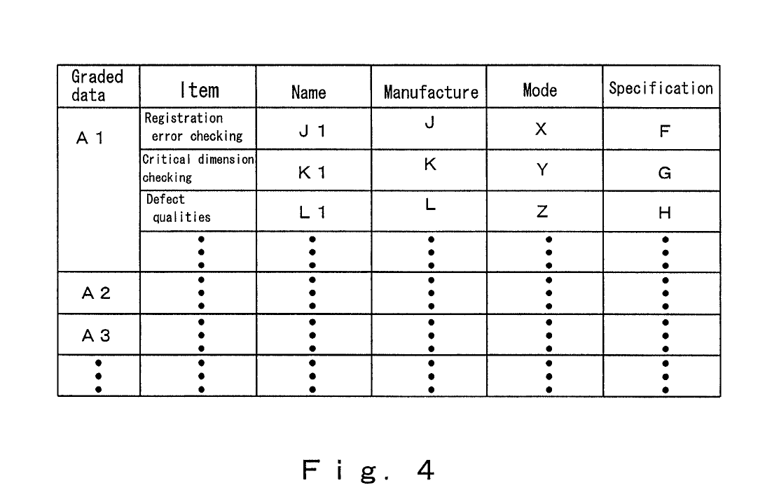

FIG. 4 is a table showing data stored in the inspection item data hold section in the quality assurance automatic display system according to the second embodiment. For example, as illustrated, an inspection about the registration (long dimension) of a pattern to be performed by a first inspection apparatus is assigned inspection item graded data consisting of the name of an inspection apparatus (J1), a manufacturer of the inspection apparatus (J), an inspection mode (X), and an inspection specification (F). From these data sets, inspection item graded data are determined to be A1. An inspection about the critical dimension of a pattern to be performed by a second inspection apparatus is assigned inspection item graded data consisting of the name of an inspection apparatus (K1), a manufacturer of the inspection apparatus (K), an inspection mode (Y), and an inspection specification (G). From these data sets, inspection item graded data are determined to be A1. An inspection about defect qualities of a pattern to be performed by a third inspection apparatus is assigned inspection item graded data consisting of the name of an inspection apparatus (L1), a manufacturer of the inspection apparatus (L), an inspection mode (Z), and an inspection specification (H). From these data sets, inspection item graded data are determined to be A1. Inspection item graded data are determined with regard to a plurality of inspection items.

As in the first embodiment, the inspection item graded data are transported to a data processing section, where general graded data are determined on the basis of the inspection item graded data sets. Finally, the general graded data are transported to the display device, where the data are provided on a photomask.

At this time, the general graded data are provided in an area within a pattern region on the photomask (i.e., the region is exposed to illumination light originating from an illumination optical system and is involved in projecting a pattern) in which no pattern is to be formed. A projection aligner projects the general graded data provided on the photomask onto an object to be exposed, such as a semiconductor substrate, through exposure. Thus, general graded data are formed in an area on an object to be exposed other than the area where a pattern is to be actually formed.

As has been described, in the quality assurance automatic display system embodied in the manner as mentioned in connection with the second embodiment, when the quality of a photomask and the quality of an object to be exposed through use of the photomask are to be assured, inspections are graded in consideration of, for each inspection item, variations in the reliability of inspections attributable to a difference in pieces of inspection apparatus and in inspection methods. Further, the resultant grades are provided on a photomask and on an object to be exposed through use of the photomask. As a result, the user can ascertain the correct degree of quality assurance.

In the second embodiment, general graded data are provided within a pattern region on a photomask. Alternatively, general graded data can be provided outside the pattern region on the photomask (i.e., an area which is not involved in projecting a pattern).

When the object to be exposed in the second embodiment corresponds to a wafer, general graded data can be provided only in a TEG pattern section on the wafer.

In the previous embodiments, a semiconductor device or a photomask is taken as an object to be inspected. However, the present invention can also be applied to an industrial product, such as a photomask indirect material such as a blank, as well as to semiconductor devices and photomasks. For instance, a blank serving as raw material of a photomask is subjected to inspections with regard to inspection items; namely, the flatness of a formed metal film, the reflectivity and transmissivity of the metal film, and defect qualities such as pinholes. As in the previous embodiments, inspection item graded data and general graded data are determined sequentially, and the general graded data are printed on a blank.

### Third Embodiment

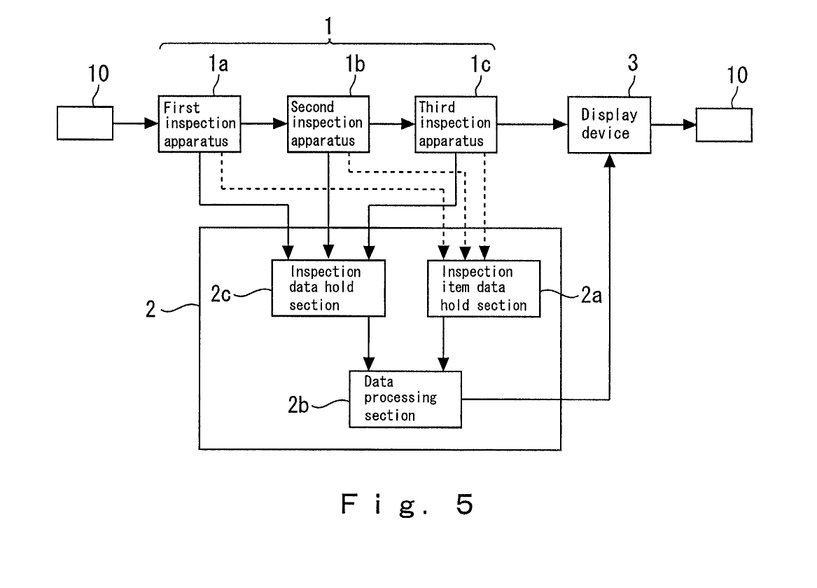

A third embodiment of the present invention will now be described in detail by reference to drawings. FIG. 5 is a block diagram showing the quality assurance automatic display system according to a third embodiment of the present invention. The quality assurance automatic display system according to the third embodiment differs from that described in connection with the first embodiment only in that the data processor is further equipped with an inspection data hold section for holding inspection data produced by individual pieces of inspection apparatus.

As shown in FIG. 5, reference numeral 1 designates pieces of inspection apparatus; 1a designates a first inspection apparatus; 1b designates a second inspection apparatus; 1c designates a third inspection apparatus; 2 designates a data processor; 2a designates an inspection item data hold section; 2b designates a data processing section; and 2c designates an inspection data hold section.

In the quality assurance automatic display system embodied in the manner as mentioned above, the semiconductor device 10 is transported sequentially to the first inspection apparatus 1a, the second inspection apparatus 1b, and the third inspection apparatus 1c, as in the case of the first embodiment. Inspection data pertaining to the inspections performed by the inspection apparatus 1a, 1b, and 1c are transported to and stored in the inspection data hold section 2c of the data processor 2.

As in the case of the first embodiment, inspection item graded data pertaining to inspection items assigned to the respective pieces of the inspection apparatus 1a, 1b, and 1c are input to and held in the inspection item data hold section 2a of the data processor 2.

The inspection data held in the inspection data hold section 2c and the inspection item graded data held in the inspection item data hold section 2a are transported to the data processing section 2b provided in the data processor 2. Subsequently, general graded data pertaining to the degree of quality assurance of the semiconductor devices 10 are determined by means of an algorithm employed in the data processing section 2b.

It may be the case that information pertaining to “specifications” such as those shown in FIG. 2 are not input to the inspection item data hold section 2a. In this case, inspection item graded data are determined on the basis of only the inspection apparatus and the inspection mode. General graded data pertaining to each of the semiconductor devices 10 are determined on the basis of the inspection data pertaining to each of the inspection items and corresponding inspection item graded data.

The general graded data determined by the data processing section 2b are transported to the display device 3, where general graded data are provided on each of the semiconductor devices 10.

As has been described, in the quality assurance automatic display system embodied in the manner as described in connection with the third embodiment, even when specifications to be used for identifying the semiconductor device 10 as non-defective or defective have not yet been determined during the course of development of the semiconductor device 10, the quality of individual semiconductor devices 10 can be ascertained.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2001-085098, filed on Mar. 23, 2001 including specification, claims, drawings and summary, on which the Convention priority of the present application is based, are incorporated herein by reference in its entirety.

What is claimed is:

1. A quality assurance automatic display system comprising:
a data processor having an inspection item data hold section and a data processing section;
the inspection item data hold section holding inspection item graded data which have been graded by determination of reliability of a per-inspection-item for a substance to be inspected; and
the data processing section determining general graded data pertaining to the degree of quality assurance of the substance in accordance with an algorithm employed in the data processing section after having received the inspection item graded data from the inspection item data hold section; and
a display device for displaying the general graded data transported from the data processing section.

2. The quality assurance automatic display system according to claim 1, wherein the data processor further comprises an inspection data hold section for holding inspection data pertaining to the substance for each of the inspection items, and the general graded data are determined in the data processing section on the basis of both the inspection item graded data and the inspection data transported from the inspection data hold section

3. The quality assurance automatic display system according to claim 1, wherein the inspection item graded data are produced as a result of a determination being made by means of taking, as references, an inspection apparatus and an inspection method corresponding to the inspection item.

4. The quality assurance automatic display system according to claim 1, wherein the display device is a printer which prints the general graded data directly onto the substance.

5. The quality assurance automatic display system according to claim 1, wherein the substance to be inspected corresponds to a semiconductor device, a photomask, or photomask indirect material.

6. The quality assurance automatic display system according to claim 1, wherein the substance to be inspected 2is a photomask, and the display device is constructed so as to provide the general graded data on an area within a pattern region on the photomask in which no pattern is to be formed.
